(19) United States
(12) Patent Application Publication
(10) Pub. No.: US 2019/0323774 A1
(43) Pub. Date: Oct. 24, 2019

(54) HEAT RECOVERY APPARATUS, SYSTEM AND METHOD OF USING THE SAME

(71) Applicants: METOXS PTE. LTD., Singapore (SG); Arizona Board of Regents on Behalf of the University of Arizona, Tucson, AZ (US)

(72) Inventors: Peiwen LI, Tucson, AZ (US); Dominic Francis Gervasio, Tucson, AZ (US); Abraham Fouad Jalbout, Tucson, AZ (US)

(21) Appl. No.: 16/313,826

(22) PCT Filed: Jun. 30, 2017
(86) PCT No.: PCT/US17/40211

§ 371 Date: Dec. 27, 2018

Related U.S. Application Data
(60) Provisional application No. 62/357,182, filed on Jun. 30, 2016.

(51) Int. Cl. F27D 17/00; F27D 15/02

(52) U.S. Cl. CPC F27D 17/004; F28D 21/0001; F27D 15/0266

(57) ABSTRACT

A heat recovery apparatus, system and method of using the same. The heat recovery apparatus includes a support structure having a central passageway extending through the heat recovery apparatus and configured to house at least a portion of a slag conveyor, and a cavity located above the central passageway, the cavity having a plurality of pipes configured for transmission of a heat transfer fluid therethrough.

### CROSS REFERENCE TO RELATED APPLICATIONS

This application is claims the benefit of U.S. Provisional Application Ser. No. 62/357,182, filed Jun. 30, 2016, the entire contents of which are incorporated herein by reference.

### TECHNICAL FIELD

The application generally relates to heat recovery apparatuses, systems, and methods of using the same. In particular, the application relates to apparatuses, systems, and methods for the recovery of energy, in the form of heat, from high temperature solid particulate or molten liquid such as slag by-product produced during the smelting or refining of metal-containing ores.

### BACKGROUND

Generally, as a by-product of smelting or refining processes to purify metal-containing ores or crude metals, respectively, a large amount of high temperature molten slag is produced. The produced slag by-product is then separated from the desired metal product and generally allowed to cool naturally in an open environment or with the aid of water. Upon cooling, the molten slag forms into a solid which may be a mixture of, for example, silicates, sulfides, chlorides, fluorides, and other chemical components or compositions. The solidified slag may then be granulated for use in the production of, for example, ballast, concrete or glass compositions.

During the cooling process, a considerable amount of energy is liberated from the slag by-product. The above referenced natural or water cooling methods are not advantageous however because the heat (that is, energy) released during the cooling process is not recovered for later use. Molten slag can have a temperature ranging from about 1200° C. to about 1600° C. depending on the compositions of the ore to be purified and of the produced slag. As energy is released from the molten slag will begin to solidify and can be granulated by, for example, agitation or mechanical grinding. In general, solidification and/or granulation of molten slag can take place at temperatures ranging from about 700° C. to about 1100° C., depending on the composition of the slag.

### BRIEF DESCRIPTION OF THE DRAWINGS

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

FIG. 1 is an environmental view of a heat recovery system having a heat recovery apparatus 100 in accordance with one or more aspects of the present disclosure;

FIG. 2 is a front side cross-sectional view of the heat recovery apparatus 100 in accordance with one or more aspects of the present disclosure;

FIG. 3 is a right side cross-sectional view of the heat recovery apparatus 100 in accordance with one or more aspects of the present disclosure; and

FIG. 4 is a right side cross-sectional view of the heat recovery apparatus 100 and an alternative conveyor system 480 in accordance with one or more aspects of the present disclosure.

### DETAILED DESCRIPTION

The following detailed description refers to the accompanying drawings that depict various details of examples selected to show how the disclosed subject matter may be practiced. The discussion addresses various examples of the disclosed subject matter at least partially in reference to these drawings, and describes the depicted embodiments in sufficient detail to enable those skilled in the art to practice the disclosed subject matter. Many other embodiments may be utilized for practicing the disclosed subject matter other than the illustrative examples discussed herein, and structural and operational changes in addition to the alternatives specifically discussed herein may be made without departing from the scope of the disclosed subject matter.

Several definitions that apply throughout this disclosure will now be presented. The term “coupled” is defined as connected, whether directly or indirectly through intervening components, and is not necessarily limited to physical connections. The connection can be such that the objects are permanently connected or releasably connected. The term “fluidically coupled” is defined as connected, either directly or indirectly through intervening components, for the transfer of one or more fluids, gases, or solid particles or grains, between the so-described components. The term “substantially” is defined to be essentially conforming to the particular dimension, shape or other thing that “substantially” modifies, such that the component need not be exact. For example, substantially cylindrical means that the object resembles a cylinder, but can have one or more deviations from a true cylinder. The terms “comprising,” “including” and “having” are used interchangeably in this disclosure. The terms “comprising,” “including” and “having” mean to include, but are not necessarily limited to, the things so described.

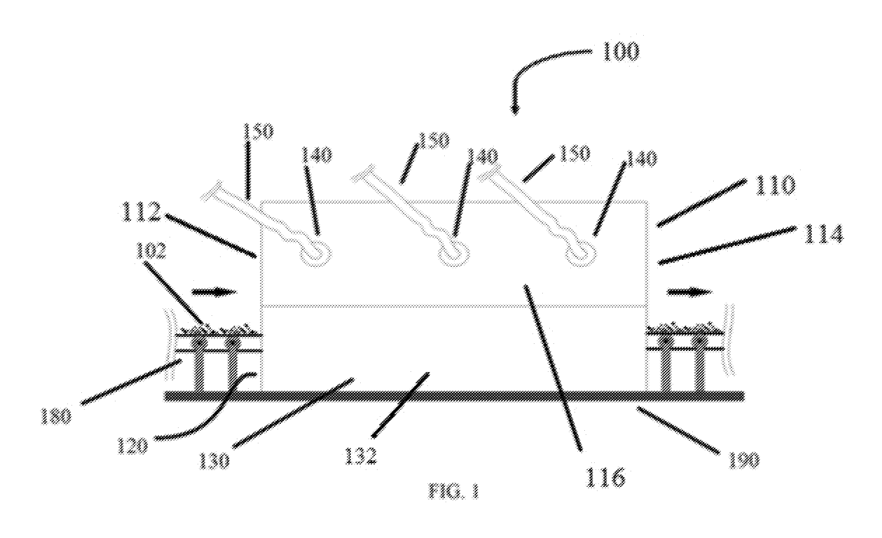

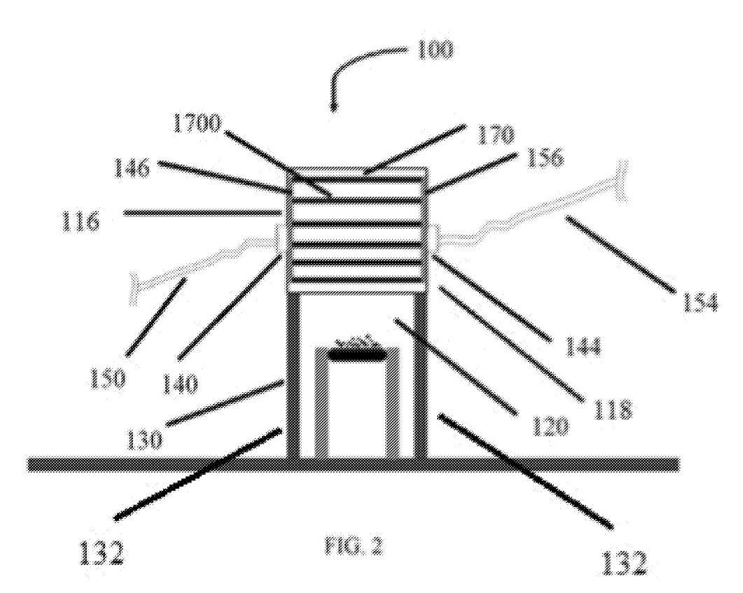

FIG. 1 is an environmental view of a heat recovery system having a heat recovery apparatus 100 in accordance with one or more aspects of the present disclosure. The heat recovery system includes a heat recovery apparatus 100 and a hot slag conveyor 180. The heat recovery apparatus 100 includes a heat transfer body 110 and a support structure 130. The support structure 130 includes a central passageway 120 extending longitudinally through the heat recovery apparatus 100 and configured to house at least portion of the slag conveyor 180. The heat transfer body 110 includes a front side 112, a back side 114, a right side 116 and a left side 118 (FIG. 2). One or more fluid inlets 140 are located on the right side 116 and a corresponding number of fluid outlets 144 (FIG. 2) are located on the left side 118. In some instances, the fluid inlets 140 can be located on the left side 118 and the fluid outlets 144 can be located on the right side 116. Each fluid inlet 140 is fluidically coupled with a heat transfer fluid source (not shown) via a hose 150. Each fluid inlet 140 can be fluidically coupled with the same heat transfer fluid source or a different heat transfer fluid source. Each fluid outlet 144 is fluidically coupled with a heated heat transfer fluid reservoir (not shown) via a hose 154 (FIG. 2). Each fluid outlet 144 can be fluidically coupled with the same heated heat transfer fluid reservoir or a different heated heat transfer fluid reservoir.

In FIG. 1, the heat recovery apparatus 100 has three heat transfer fluid inlets 140. In some instances, the heat recovery apparatus 100 can have one or two heat transfer fluid inlets 140. In some instances, the heat recovery apparatus 100 can have more than three heat transfer fluid inlets 140. In general, each fluid inlet 140 will have a corresponding fluid outlet 144. In some instances the number of fluid inlets 140 will not equal the number of fluid outlets 144. For example, in some instances, the heat recovery apparatuses can have one fluid inlet 140 and a plurality of fluid outlets 144, with each fluid outlet 144 fluidically coupled with a different heated heat transfer fluid reservoir.

The heat recovery apparatus 100 is coupled with a suitable base support 190 via weight bearing vertical beams 132 located on the right side 116 and a left side 118. The base support 190 can be, for example, the ground, a concrete slab or foundation, or a raised platform structure. The slag conveyor 180 transmits a uniformly distributed hot slag composition 102 through the central passageway 120 of the heat recovery apparatus 100. The heat recovery system can be used to recover energy, in the form of heat, from hot solidified, partially solidified, or molten slag. In general, molten slag can begin to solidify at temperatures ranging from about 700° C. to about 1100° C., depending on the composition of the slag. Before entering the central passageway 120, solidified slag can be granulated to increase the surface area of the solidified slag, forming a uniform distribution of slag on the slag conveyor, and enhance the liberation of heat therefrom as it is conveyed through central passageway 120 of the heat recovery apparatus 100 as described below. While the above describes the use of the heat recovery system for the recovery of heat from slag, one of ordinary skill in the art will appreciate that the heat recovery system can be used to recover energy, in the form of heat, form any hot or molten fluid or solid material. For example, particles of sand or ceramic compositions can be heated by, for example regular or concentrated solar energy to about 600° C. to about 1000° C. and subsequently introduced into the heat recovery apparatus 100 as well.

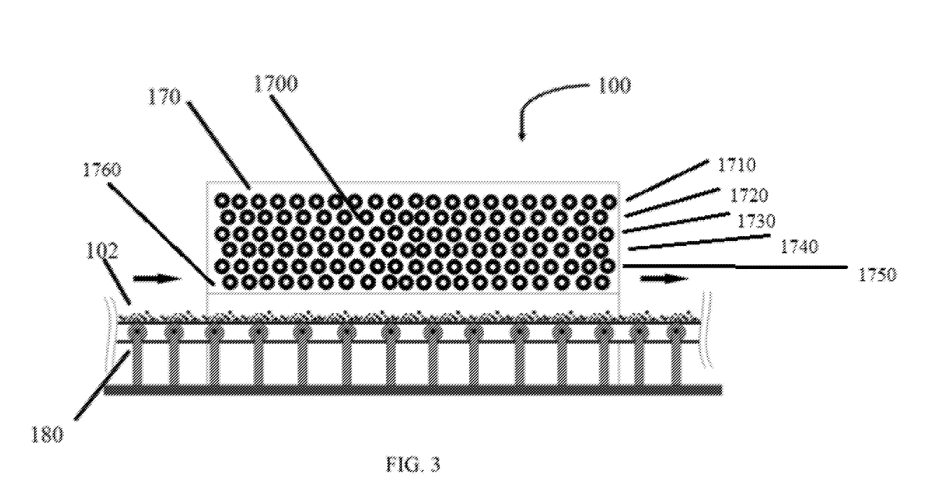

FIG. 2 is a front side cross-sectional view of the heat recovery apparatus 100 and FIG. 3 is a right side cross-sectional view of the heat recovery apparatus 100 in accordance with one or more aspects of the present disclosure. In FIG. 2, the heat transfer body 110 includes a cavity 170 having a plurality of pipes 1700. Each of the plurality of pipes 1700 has a longitudinal passageway for the transmission of a heat transfer fluid therethrough from a fluid inlet 140 to a fluid outlet 144. The slag conveyor 180 transmits the uniformly distributed hot slag composition 102 through the central passageway 120 of the heat recovery apparatus 100. As the hot slag composition 102 passes through the central passageway 120, energy in the form of heat is transferred from the hot slag composition 102 to the heat transfer fluid via thermal radiation or convection. The slag conveyor 180, when used to transmit a solid slag composition, can have a grading apparatus, a mechanical grinder or shaker coupled therewith which can convert irregularly shaped bulk hot slag composition 102 into a granulated and uniform layer of hot slag composition 102 on the hot slag conveyor 190. Formation of a uniform layer of hot slag 102 prior to transmission to the particulate inlet 120 of the heat recovery apparatus 100 can increase the surface area of hot slag 102 transmitted through of the heat recovery apparatus 100 and therefore increase the efficiency of heat transfer to the plurality of pipes 1700, and the heat transfer fluid contained therein, over a defined period of time. Components of the slag conveyor 180 should be fabricated from materials which are suitable to carry molten or solidified slag without the potential of melting of the components.

The plurality of pipes 1700 are fluidically coupled with the one or more fluid inlets 140 via one or more inlet manifolds 146. The plurality of pipes 1700 are also fluidically coupled with the one or more fluid outlets 144 via one or more outlet manifolds 156. The one or more inlet manifolds 156 dispense the heat transfer fluid, from the one or more fluid inlets 140, into each of the plurality of pipes 1700 and the one or more outlet manifolds 156 combine the heated heat transfer fluid into one or more single fluid streams which are subsequently transmitted to the heated heat transfer fluid reservoir(s) via the one or more fluid outlets 144 and the hoses 154. Each fluid inlet 140 and inlet manifold 146, and each corresponding fluid outlet 144 and outlet manifold 156, can be associated with a predefined number of pipes of the plurality of pipes 1700. For example, if the heat recovery apparatus 100 has three fluid inlets 140 (and three corresponding inlet manifolds 146) and three fluid outlets 144 (and three corresponding outlet manifolds 156) the plurality of pipes 1700 can be segmented into three groupings of pipes with each grouping corresponding to a defined fluid inlet 140 (and corresponding inlet manifold 146) and a defined fluid outlet 144 (and a corresponding outlet manifold 156). Additionally, for example, if the heat recovery apparatus 100 has one fluid inlet 140 (and one corresponding inlet manifolds 146) and three fluid outlets 144 (and three corresponding outlet manifolds 156) the plurality of pipes 1700 can be segmented into three groupings of pipes, each grouping corresponding to the single fluid inlet 140 (and corresponding inlet manifold 146) and one of the three fluid outlets 144 (and the three corresponding outlet manifolds 156).

In some instances, the cavity 170 can be lined or coated with an insulating material and/or a reflective material to direct the transfer of heat from the uniformly distributed hot slag composition 102 toward the plurality of pipes 1700 and inhibit the transfer of heat to other components of the heat recovery apparatus 100. In some instances, the cavity can include a gas exhaust for releasing toxic gas(es) which is liberated from the hot slag composition 102 as it cools. The gas exhaust can be fluidically coupled with, for example, a purification and/or gas sequestration apparatus. Each of the plurality of pipes 1700 can be made from any suitable material known to one of ordinary skill in the art. The primary limitation to the material from which each of the plurality of pipes 1700 is made is that such material should have a melting point sufficiently above the temperature of the hot particulate 102. In general, each of the plurality of pipes 1700 can be made from a metal such as iron or copper, or an alloy such as cast iron, steel (stainless, low-carbon, medium-carbon, or high-carbon), Inconel®, Incoloy®, or Hastelloy®.

The heat transfer fluid can be any suitable heat transfer fluid known to one of ordinary skill in the art. In some instances, the heat transfer fluid can be a liquid or aqueous solution such as, for example, water, salt water, a eutectic mixture of biphenyl (C₁₂H₁₀) and diphenyl oxide (C₁₂H₁₀₀), compositions comprising terphenyls and/or quaterphenyls or derivatives thereof, a silicone-based fluid, a propylene glycol- or ethylene glycol-based fluid, an oil containing one or more aliphatic and/or aromatic hydrocarbons, a molten salt mixture comprising one or more nitrates (potassium, sodium, calcium and lithium), any combination thereof, or any other suitable liquid or aqueous heat transfer fluids. In other instances, the heat transfer fluid can be a compressed or ambient pressure gas such as, for example, air, hydrogen, helium, steam, carbon dioxide, argon, natural gas, any suitable combination thereof, or any other suitable gas-phase heat transfer fluid. In yet other instances, the heat transfer fluid can be a combination of one or more gases and one or more liquids or aqueous solutions. In yet other instances, the heat transfer fluid can be a liquid or aqueous solution that converts to a gas when heated in the plurality of pipes 1700.

The heat transfer fluid source(s) can be, for example, a vessel, receptacle, tank, or any other suitable storage means. The heated heat transfer fluid reservoir(s) can also be, for example, a vessel, receptacle, tank, or any other suitable storage means. The heated heat transfer fluid reservoir(s) can be coupled with an external energy conversion system, such as for example, a steam engine or turbine, a piston, a thermoelectric device, a base load electricity generation system, a water heater, an energy recovery ventilator, a heat recover ventilator, or a rotary heat exchanger, for converting the energy absorbed by the heat transfer fluid to another form of usable energy. In some instances, a pump can be incorporated between the heat transfer fluid source(s) and the fluid inlet(s) 150 to apply a positive pressure to the heat transfer fluid and “push” the heat transfer fluid through the plurality of pipes 1700. In some instances a vacuum pump can be incorporated between the outlet pump and the heated heat transfer fluid reservoir(s) to apply a partial vacuum, or negative pressure relative to atmospheric pressure, to the heat transfer fluid and “pull” the heat transfer fluid through the plurality of pipes 1700. In some instances, both a pump and vacuum pump, can be used. In some instances, the heat transfer fluid source can itself be pressurized such as, for example by compressed air or supercritical carbon dioxide (CO₂).

In some instances, one or more of the heat transfer fluid sources and a corresponding one of the one or more heated heat transfer fluid reservoirs can be fluidically coupled to form a closed-loop system. When one of the heat transfer fluid sources and one of the heated heat transfer fluid reservoirs are fluidically coupled to form a closed-loop system, the heat transfer fluid can be recycled and reused continuously by the heat recovery apparatus 100. In some instances, when a closed-loop system is used, a pump can be incorporated between the heat transfer fluid source and the corresponding fluid inlet 150 to apply a positive pressure to the heat transfer fluid and “push” the heat transfer fluid through the plurality of pipes 1700. In some instances, when a closed-loop system is used, a vacuum pump can be incorporated between the outlet pump and the heated heat transfer fluid reservoir to apply a partial vacuum, or negative pressure relative to atmospheric pressure, to the heat transfer fluid, and “pull” the heat transfer fluid through the plurality of pipes 1700. In some instances, when a closed-loop system is used, both a pump and vacuum pump can be used.

In FIG. 3, the plurality of pipes 1700 are oriented in six planar or substantially planar rows 1710, 1720, 1730, 1740, 1750, and 1760 respectively. In some instances the plurality of pipes can be oriented in less than six rows such as two to five planar or substantially planar rows. In some instances more than six planar or substantially planar rows of pipes can form the plurality of pipes 1700 such as, for example seven to thirty rows. In some instances each row of pipes are not planar or substantially planar. Specifically, in some instances, each row of pipes can be, for example concave, convex, or have a serpentine or oscillating shape.

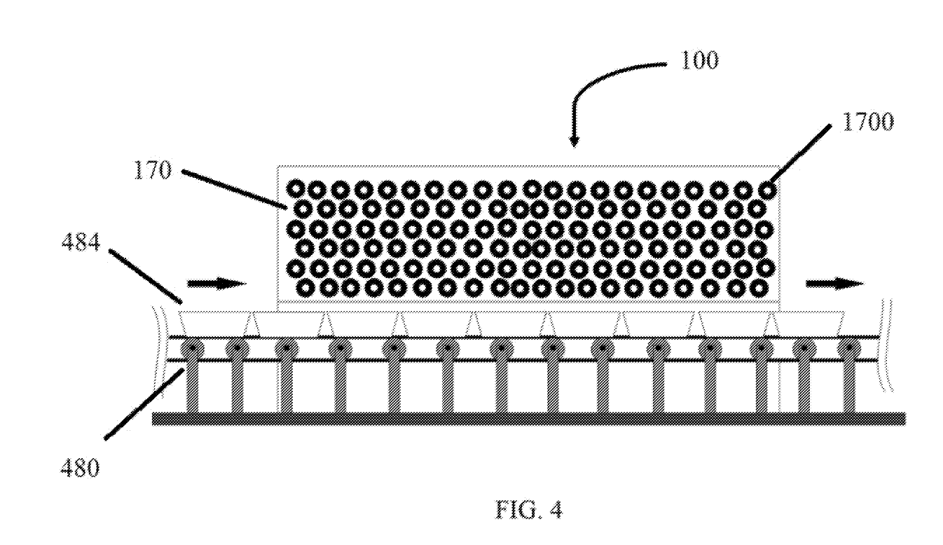

FIG. 4 is a right side cross-sectional view of the heat recovery apparatus 100 and an alternative hot slag conveyor 480 in accordance with one or more aspects of the present disclosure. The hot slag conveyor 480 includes a plurality of slag plates 484 coupled with an upper surface of the hot slag conveyor 480. The plurality of slag plates 484 can be used to hold a molten (i.e., liquid), granulated, partially granulated, or ungranulated slag composition. One of ordinary skill in the art will appreciate that the conveyor 480 can be substituted with other means for transmission of the plurality of slag plates 484 through the heat recovery apparatus 100. For example, in some instances, rather than the conveyor 480, each of the plurality of slag plates 484 can include one or more sets of wheels on a bottom portion thereof, where the wheels are configured to engage a set of tracks extending through the central passageway 120 (FIGS. 1 and 2) for transmission of the molten slag composition through the heat recovery apparatus 100. Furthermore, in some instances, rather than the conveyor 480, a suspension wire can extend through the central passageway 120 and each of the slag plates 484 can coupled with the suspension wire for transmission of the molten slag composition through the heat recovery apparatus 100.

### STATEMENTS OF THE DISCLOSURE

Statements of the Disclosure include:

Statement 1: A heat recovery system comprising a hot composition conveyor; and a heat recovery apparatus comprising a support structure having a central passageway extending through the heat recovery apparatus and housing at least a portion of the hot composition conveyor; and a cavity located above the central passageway, the cavity comprising a plurality of pipes configured for transmission of a heat transfer fluid therethrough.

Statement 2: A heat recovery system according to Statement 1, wherein the heat recovery apparatus further comprises a heat transfer fluid inlet; an inlet manifold fluidically coupling the fluid inlet and the plurality of pipes; a heat transfer fluid outlet; and an outlet manifold fluidically coupling the fluid outlet and the plurality of pipes.

Statement 3: A heat recovery system according to Statement 2, further comprising a heat transfer fluid source fluidically coupled with the fluid inlet; and a heat transfer fluid reservoir fluidically coupled with the fluid outlet.

Statement 4: A heat recovery system according to Statement 3, wherein the heat transfer fluid reservoir is fluidically coupled with an external energy conversion system.

Statement 5: A heat recovery system according to Statement 4, wherein the heat transfer fluid source, the heat recovery apparatus, the heat transfer fluid reservoir, and the external energy conversion system form a closed-loop system.

Statement 6: A heat recovery system according to any one of Statements 1-5, wherein the hot composition is any one of ungranulated, partially granulated, or granulated slag.

Statement 7: A heat recovery system according to any one of Statements 1-5, wherein the conveyor further comprises a plurality of plates, each plate configured hold an amount of the hot composition.

Statement 8: A heat recovery system according to Statement 7, wherein the conveyor is a suspension wire and the plurality of plates are suspended therefrom.

Statement 9: A heat recovery system according to Statement 7 or Statement 8, wherein the hot composition is any one of molten, ungranulated, partially granulated, or granulated slag.

Statement 10: A heat recovery system according to any one of Statements 1-9, wherein the heat transfer fluid comprises a gas.

Statement 11: A heat recovery system according to any one of Statements 1-10, wherein the heat transfer fluid comprises a liquid or an aqueous solution.

Statement 12: A heat recovery system according to any one of Statements 1-11, wherein the plurality of pipes are oriented into one or more rows, the rows being any one of planar, convex, concave and oscillating in shape.

Statement 13: A heat recovery apparatus comprising a support structure having a central passageway extending through the heat recovery apparatus and configured to house at least a portion of a hot composition conveyor; and a cavity located above the central passageway, the cavity comprising a plurality of pipes configured for transmission of a heat transfer fluid therethrough.

Statement 14: A heat recovery apparatus according to Statement 13, further comprising a heat transfer fluid inlet; an inlet manifold fluidically coupling the fluid inlet and the plurality of pipes; a heat transfer fluid outlet; and an outlet manifold fluidically coupling the fluid outlet and the plurality of pipes.

Statement 15: A heat recovery apparatus according to Statement 13 or Statement 14, wherein the plurality of pipes are oriented into one or more rows, the rows being any one of planar, convex, concave and oscillating in shape.

Statement 16: A method for recovering heat from hot composition comprising transmitting, via a conveyor, a hot composition through a heat recovery apparatus, the heat recovery apparatus comprising a support structure having a central passageway extending through the heat recovery apparatus and configured to house at least a portion of the slag conveyor, and a cavity located above the central passageway, the cavity comprising a plurality of pipes configured for transmission of a heat transfer fluid therethrough; circulating a heat transfer fluid through the plurality of pipes; and transferring heat from the hot composition to the circulating heat transfer fluid.

Statement 17: A method according to Statement 16, wherein the hot composition is slag.

Statement 18: A method according to Statement 17, wherein the slag is at least partially granulated.

Statement 19: A method according to Statement 17, wherein the slag is molten.

Statement 20: A method according to any one of Statements 16-19, wherein the heat recovery apparatus further comprises a heat transfer fluid inlet; an inlet manifold fluidically coupling the fluid inlet and the plurality of pipes; a heat transfer fluid outlet; and an outlet manifold fluidically coupling the fluid outlet and the plurality of pipes.

Statement 21: A method according to Statement 20 wherein the heat recovery apparatus further comprises a heat transfer fluid source fluidically coupled with the fluid inlet; and a heat transfer fluid reservoir fluidically coupled with the fluid outlet.

Statement 22: A method according to Statement 21, wherein the heat transfer fluid reservoir is fluidically coupled with an external energy conversion system.

Statement 23: A method according to Statement 22, further comprising transmitting the heat transfer fluid from the heat transfer fluid reservoir to the external energy conversion system.

Statement 24: A method according to Statement 22 or Statement 23, wherein the heat transfer fluid source, the heat recovery apparatus, the heat transfer fluid reservoir, and the external energy conversion system form a closed-loop system.

Statement 25: A method according to any one of Statements 22-24, further comprising transmitting the heat transfer fluid from the external energy conversion system to the heat transfer fluid source.

Statement 26: A method according to any one of Statements 16-25, wherein the conveyor further comprises a plurality of plates, each plate configured to hold an amount of the hot composition.

Statement 27: A method according to Statement 26, wherein the conveyor is a suspension wire and the plurality of plates are suspended therefrom.

Statement 28: A method according to any one of Statements 16-27, wherein the heat transfer fluid comprises a gas.

Statement 29: A method according to any one of Statements 16-28, wherein the heat transfer fluid comprises a liquid or an aqueous solution.

Statement 30: A method according to any one of Statements 16-29, wherein the plurality of pipes are oriented into one or more rows, the rows being any one of planar, convex, concave and oscillating in shape.

The embodiments shown and described above are only examples. Many details are often found in the art such as the other features of a heat recovery system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

1. A heat recovery system comprising:
a hot composition conveyor; and
a heat recovery apparatus comprising:
a support structure having a central passageway extending through the heat recovery apparatus and housing at least a portion of the hot composition conveyor; and
a cavity located above the central passageway, the cavity comprising a plurality of pipes configured for transmission of a heat transfer fluid therethrough.

2. The heat recovery system of claim 1, wherein the heat recovery apparatus further comprises:
a heat transfer fluid inlet;
an inlet manifold fluidically coupling the fluid inlet and the plurality of pipes;
a heat transfer fluid outlet; and
an outlet manifold fluidically coupling the fluid outlet and the plurality of pipes.

3. The heat recovery system of claim 2, further comprising:
a heat transfer fluid source fluidically coupled with the fluid inlet; and
a heat transfer fluid reservoir fluidically coupled with the fluid outlet.

4. The heat recovery system of claim 3, wherein the heat transfer fluid reservoir is fluidically coupled with an external energy conversion system.

5. The heat recovery system of claim 4, wherein the heat transfer fluid source, the heat recovery apparatus, the heat transfer fluid reservoir, and the external energy conversion system form a closed-loop system.

6. The heat recovery system of claim 1, wherein the hot composition is any one of molten, ungranulated, partially granulated, or granulated slag.

7. The heat recovery system of claim 1, wherein the hot composition conveyor further comprises a plurality of plates, each plate configured hold an amount of the hot composition.

8. The heat recovery system of claim 7, wherein the conveyor is a suspension wire and the plurality of plates are suspended therefrom.

9. (canceled)

10. The heat recovery system of claim 1, wherein the heat transfer fluid comprises a gas, a liquid, or an aqueous solution.

11. (canceled)

12. The heat recovery system of claim 1, wherein the plurality of pipes are oriented into one or more rows, the rows being any one of planar, convex, concave and oscillating in shape.

13. A heat recovery apparatus comprising:
a support structure having a central passageway extending through the heat recovery apparatus and configured to house at least a portion of a hot composition conveyor; and
a cavity located above the central passageway, the cavity comprising a plurality of pipes configured for transmission of a heat transfer fluid therethrough.

14. The heat recovery apparatus of claim 13, further comprising:
a heat transfer fluid inlet;
an inlet manifold fluidically coupling the fluid inlet and the plurality of pipes;
a heat transfer fluid outlet; and
an outlet manifold fluidically coupling the fluid outlet and the plurality of pipes.

15. The heat recovery apparatus of claim 13, wherein the plurality of pipes are oriented into one or more rows, the rows being any one of planar, convex, concave and oscillating in shape.

16. A method for recovering heat from a hot composition comprising:
transmitting, via a conveyor, a hot composition through a heat recovery apparatus, the heat recovery apparatus comprising:
a support structure having a central passageway extending through the heat recovery apparatus and configured to house at least a portion of the conveyor; and
a cavity located above the central passageway, the cavity comprising a plurality of pipes configured for transmission of a heat transfer fluid therethrough;
circulating a heat transfer fluid through the plurality of pipes; and
transferring heat from the hot composition to the circulating heat transfer fluid.

17. The method of claim 16, wherein the hot composition is any one of molten, ungranulated, partially granulated, or granulated slag.

18-19. (canceled)

20. The method of claim 16, wherein the heat recovery apparatus further comprises:
a heat transfer fluid inlet;
an inlet manifold fluidically coupling the fluid inlet and the plurality of pipes;
a heat transfer fluid outlet; and
an outlet manifold fluidically coupling the fluid outlet and the plurality of pipes.

21. The method of claim 20, wherein the heat recovery apparatus further comprises:
a heat transfer fluid source fluidically coupled with the fluid inlet; and
a heat transfer fluid reservoir fluidically coupled with the fluid outlet.

22. The method of claim 21, wherein the heat transfer fluid reservoir is fluidically coupled with an external energy conversion system and the method further comprises transmitting the heat transfer fluid from the heat transfer fluid reservoir to the external energy conversion system.

23. (canceled)

24. The method of claim 22, wherein the heat transfer fluid source, the heat recovery apparatus, the heat transfer fluid reservoir, and the external energy conversion system form a closed-loop system.

25. The method of claim 24, further comprising transmitting the heat transfer fluid from the external energy conversion system to the heat transfer fluid source.

26. The method of claim 16, wherein the conveyor further comprises a plurality of plates, each plate configured to hold an amount of the hot composition.

27. The method of claim 26, wherein the conveyor is a suspension wire and the plurality of plates are suspended therefrom.

28. The method of claim 16, wherein the heat transfer fluid comprises a gas, a liquid or an aqueous solution.

29. (canceled)

30. The method of claim 16, wherein the plurality of pipes are oriented into one or more rows, the rows being any one of planar, convex, concave and oscillating in shape.
